(19) United States
(12) Patent Application Publication
(10) Pub. No.: US 2026/0324674 A1
(43) Pub. Date: Oct. 22, 2026

(54) ICE CREAM MAKER

(71) Applicant: Hangzhou Gelato Tech Co., Ltd., HANGZHOU (CN)

(72) Inventor: WEI LUO, HANGZHOU (CN)

(21) Appl. No.: 19/695,346

(22) Filed: Jun. 2, 2026

Related U.S. Application Data
(63) Continuation of application No. PCT/CN2026/090218, filed on Apr. 13, 2026.

(30) Foreign Application Priority Data
Apr. 15, 2025 (CN) 202510470991.8
Dec. 18, 2025 (CN) 202511916263.1

(51) Int. Cl. A23G 9/22; A23G 9/12; A23G 9/20

(52) U.S. Cl. CPC A23G 9/228; A23G 9/12; A23G 9/20; A23G 9/224

(57) ABSTRACT

An ice cream maker includes a machine body, at least one refrigeration container, at least one refrigeration device, and at least one stirring device. The at least one stirring device is configured to stir ice cream. The ice cream maker has an ice cream making mode and an ice cream re-overrun mode. The first condition is that a temperature of the at least one refrigeration container exceeds a preset temperature. The second condition is that a preset time is exceeded after completion of the ice cream making mode. In the ice cream re-overrun mode, the at least one refrigeration device supplies cooling energy to the at least one refrigeration container to lower the temperature of the at least one refrigeration container, and the at least one stirring device is configured to incorporate air into the ice cream by stirring the ice cream.

### TECHNICAL FIELD

The present disclosure relates to a technical field of food processing machinery and in particular to a counter-type ice cream maker for preparing and displaying ice cream.

### BACKGROUND

Ice cream, as a widely popular frozen dessert, is favored by consumers for its taste and quality. With upgrading of consumption scenarios, most consumers prefer to purchase freshly made ice cream for reasons such as fresh taste and clear visibility of hygiene conditions. Ice cream makers configured to make ice cream on-site are also known as counter-type ice cream makers. As the name implies, the counter-type ice cream makers are placed at front counters of shops facing consumers, allowing the consumers to watch an ice cream making process while waiting for their ice cream.

Overrun of ice cream is one of key factors affecting the taste and appearance of the ice cream. Ice cream with a high overrun generally has a more delicate and dense taste, and the appearance is fuller and more aesthetic. Conventional ice cream makers on the market mainly produce ice cream through two basic functions, which are refrigeration and stirring. A refrigeration device of the conventional ice cream makers is configured to lower a temperature of ice cream raw materials, causing the ice cream raw materials to gradually solidify and take shape; a stirring device thereof is configured to continuously stir the ice cream raw materials during a refrigeration process to prevent the ice cream raw materials from freezing into lumps and to promote mixing of air, thereby increasing the overrun of the ice cream.

However, during storage of the ice cream, due to factors such as fluctuations in ambient temperature and sealing performance of a storage container, the temperature of the ice cream gradually rises, which in turn leads to varying degrees of melting of the ice cream. The melting of the ice cream not only destroys its original delicate and dense taste, making the taste of the ice cream coarse and loose, but also affects fullness and aesthetics of the appearance of the ice cream, resulting in problems such as surface collapse and morphological changes of the ice cream. Furthermore, melted ice cream, after being refrozen, undergoes a change in its internal structure due to reduced air content and lower overrun, making it difficult to restore the ice cream to its original ideal state, which greatly affects the consumer's eating experience and their perception of quality of the ice cream.

In view of this, it is necessary to propose a technical solution to overcome deficiencies in the prior art.

### SUMMARY

To address aforementioned issues, the present disclosure provides an ice cream maker capable of performing a re-aeration process on the ice cream, so as to increase an air content of the ice cream and maintain an overrun rate of the ice cream, thereby rendering the ice cream finer in texture, richer in mouthfeel, and more aesthetically pleasing in appearance.

The ice cream maker is a counter-type ice cream maker for preparing and displaying ice cream. The ice cream maker comprises a machine body, at least one refrigeration container, at least one refrigeration device, and at least one stirring device.

The at least one stirring device is configured to stir ice cream within the at least one refrigeration container. The ice cream maker has an ice cream making mode and an ice cream re-overrun mode. After completion of ice cream making in the ice cream making mode, the ice cream re-overrun mode is triggered when at least one of a first condition and a second condition is met. The first condition is that a temperature of the at least one refrigeration container exceeds a preset temperature. The second condition is that a preset time is exceeded after a completion of the ice cream making mode.

In the ice cream re-overrun mode, the at least one refrigeration device is configured to supply cooling energy to the at least one refrigeration container to lower the temperature of the at least one refrigeration container, and the at least one stirring device is configured to incorporate air into the ice cream by stirring the ice cream to achieve a re-overrun of the ice cream.

Optionally, the ice cream re-overrun mode is triggered when the temperature of the at least one refrigeration container exceeds the preset temperature, and the at least one stirring device stops stirring when the temperature of the at least one refrigeration container reaches the preset temperature.

Optionally, the ice cream re-overrun mode is triggered when the temperature of the at least one refrigeration container exceeds the preset temperature, and the at least one refrigeration device stops refrigerating when the temperature of the at least one refrigeration container reaches the preset temperature.

Optionally, the ice cream re-overrun mode is triggered when the temperature of the at least one refrigeration container exceeds the preset temperature; and when the temperature of the at least one refrigeration container reaches the preset temperature, the at least one refrigeration device first stops refrigerating, and then the at least one stirring device stops stirring after a first predetermined time.

Optionally, the first predetermined time is greater than 5 seconds.

Optionally, the preset temperature is −15° C. to −3° C.

Optionally, the preset temperature is −12° C. to −5° C.

Optionally, the ice cream re-overrun mode is triggered when the preset time is exceeded after the completion of the ice cream making mode, and in the ice cream re-overrun mode, the at least one refrigeration device and the at least one stirring device are simultaneously activated for at least 10 seconds.

Optionally, the ice cream re-overrun mode is triggered when the preset time is exceeded after the completion of the ice cream making mode; and when the temperature of the at least one refrigeration container reaches the preset temperature, the at least one refrigeration device first stops refrigerating, and then the at least one stirring device stops stirring after a second predetermined time.

Optionally, the preset time is less than 25 minutes.

In the ice cream re-overrun mode, the at least one refrigeration device lowers the temperature of the ice cream in the at least one refrigeration container, and the at least one stirring device incorporates the air into the ice cream during a stirring process to increase the overrun rate of the ice cream, so that the ice cream maker achieves a re-overrun treatment during the ice cream maintaining process, thereby increasing the air content of the ice cream and maintaining the overrun rate, which makes the ice cream more delicate, richer in taste, and more aesthetic in appearance.

### BRIEF DESCRIPTION OF DRAWINGS

FIG. 1 is a schematic diagram of an ice cream maker according to one embodiment of the present disclosure.

FIG. 2 is a schematic diagram of the ice cream maker shown in FIG. 1, where transparent lids are removed.

FIG. 3 is a schematic diagram of a stirring device and a refrigeration container of the ice cream maker shown in FIG. 2.

In the drawings: 100—ice cream maker; 10—machine body; 20—refrigeration container; 21—inner wall; 211—side wall; 212—bottom wall; 22—accommodating cavity; 23—transparent lid; 30—stirring device; 31—rotating shaft; 32—stirring paddle; 40—refrigeration device; 41—refrigeration pipe.

### DETAILED DESCRIPTION

In order to make objectives, technical solutions, and advantages of the embodiments of the present disclosure clear, technical solutions in the embodiments of the present disclosure will be described clearly and completely in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

It should be noted that when a component is considered to be “connected” to another component, it can be directly connected to the other component or it may be indirectly connected to the other component through a mediation component. When a component is considered to be “arranged on” another component, it may be directly arranged on the other component or it may be arranged on the other component through a mediation component.

Unless otherwise defined, all technical and scientific terms used herein have the same meaning as commonly understood by those skilled in the art of the present disclosure. The terms used in the description of the present disclosure herein are only for the purpose of describing specific embodiments, and are not intended to limit the present disclosure. The term “and/or” used in the present disclosure includes any and all combinations of one or more of the associated listed items.

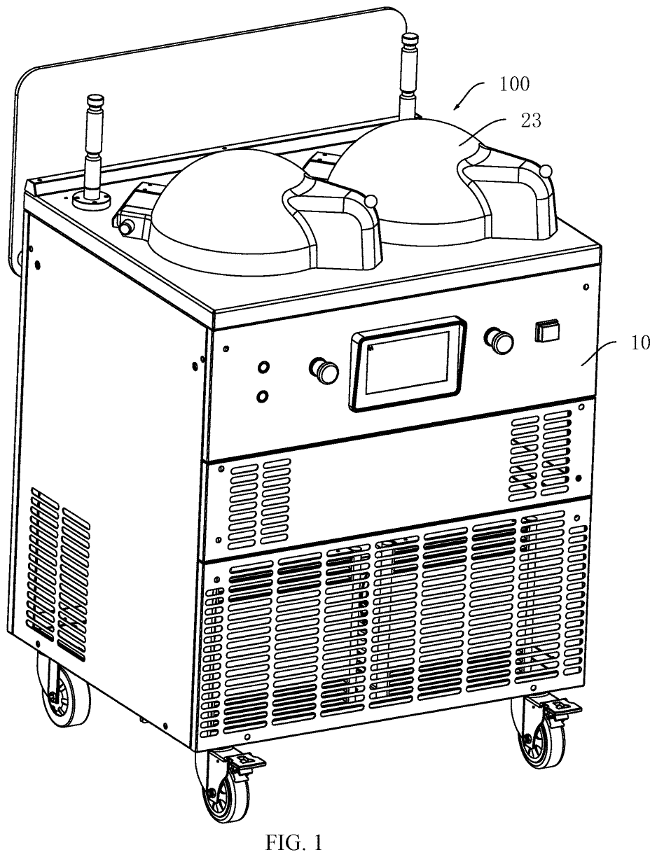

As shown in FIGS. 1-3, the present disclosure provides an ice cream maker 100, which is a counter-type ice cream maker for preparing and displaying ice cream. The ice cream maker 100 comprises a machine body 10, at least one refrigeration container 20, at least one refrigeration device 40, and at least one stirring device 30.

The at least one stirring device 30 is configured to stir ice cream within the at least one refrigeration container 20. The ice cream maker 100 has an ice cream making mode and an ice cream re-overrun mode. After completion of ice cream making in the ice cream making mode, the ice cream re-overrun mode is triggered when at least one of a first condition and a second condition is met. The first condition is that a temperature of the at least one refrigeration container 20 exceeds a preset temperature. The second condition is that a preset time is exceeded after a completion of the ice cream making mode. In the ice cream re-overrun mode, the at least one refrigeration device 40 is configured to supply cooling energy to the at least one refrigeration container 20 to lower the temperature of the at least one refrigeration container 20, and the at least one stirring device 30 is configured to incorporate air into the ice cream by stirring the ice cream to achieve a re-overrun of the ice cream.

In the ice cream re-overrun mode, the at least one refrigeration device 40 lowers the temperature of the ice cream in the at least one refrigeration container 20, and the at least one stirring device 30 incorporates the air into the ice cream during a stirring process to increase the overrun rate of the ice cream, so that the ice cream maker 100 achieves a re-overrun treatment during the ice cream maintaining process, thereby increasing the air content of the ice cream and maintaining the overrun rate, which makes the ice cream more delicate, richer in taste, and more aesthetic in appearance.

In the embodiment, the ice cream maker 100 comprises two refrigeration containers 20, two refrigeration devices 40, and two stirring devices 30, and the number of which is not limited thereto. For ease of description, one refrigeration container 20, one refrigeration device 40, and one stirring device 30 are taken as an example for illustration in the following description.

In the embodiment, in actual operation, a user is able to adjust a value of the preset temperature according to needs. For example, when the temperature is relatively high in summer, the preset temperature is set to a lower value to ensure that the ice cream undergoes an overrun treatment at a lower temperature. When the temperature is relatively low in winter, the preset temperature is set to a higher value to avoid over-freezing of the ice cream.

The preset temperature is adjusted through a control panel of the ice cream maker 100. The user is able to select an appropriate preset temperature range or a specific value according to actual requirements. When adjusting the preset temperature, care should be taken to avoid setting the preset temperature too high or too low, so as not to affect an overrun effect and taste quality of the ice cream. The preset temperature is −15° C. to −3° C.

Optionally, the preset temperature is −12° C. to −5° C. When the preset temperature is too high, the preset temperature causes the ice cream to be in a relatively soft state, and the stirring device 30 is difficult to effectively incorporate air into the ice cream during the stirring process. Because a texture of the ice cream is not hard enough, it is difficult for air to form stable bubbles therein, resulting in a decrease in the overrun rate of the ice cream. When the preset temperature is too low, the preset temperature makes the ice cream too hard, and the stirring device 30 needs to consume more energy during the stirring process and may not be able to effectively and fully stir the ice cream, which leads to uneven distribution of bubbles inside the ice cream and affects an effect of the re-overrun. Preferably, the preset temperature is −10° C. to −7° C. Further preferably, the preset threshold is −12° C., −11° C., −10° C., −9° C., −8° C., −7° C., or −6° C.

In the embodiment, the ice cream re-overrun mode is triggered when the temperature of the refrigeration container 20 exceeds the preset temperature, and the stirring device 30 stops stirring when the temperature of the refrigeration container 20 reaches the preset temperature. The ice cream re-overrun mode is triggered when the temperature of the refrigeration container 20 exceeds the preset temperature, and the refrigeration device 40 stops refrigerating when the temperature of the refrigeration container 20 reaches the preset temperature. Due to an existence of thermal inertia within the refrigeration device 40, the temperature of the ice cream does not immediately stabilize at the preset temperature, but undergoes a brief process of continuing to drop, and then gradually tends to stabilize.

In the embodiment, the ice cream re-overrun mode is triggered when the temperature of the refrigeration container 20 exceeds the preset temperature; and when the temperature of the refrigeration container 20 reaches the preset temperature, the refrigeration device 40 first stops refrigerating, and then the stirring device 30 stops stirring after a first predetermined time. Since the temperature of the ice cream does not immediately stabilize at the preset temperature but undergoes the brief process of continuing to drop before gradually stabilizing due to the thermal inertia within the refrigeration device 40, local freezing of the ice cream is avoided during a continuous stirring process of the stirring device 30. The first predetermined time is greater than 5 seconds. Optionally, the first predetermined time is greater than 10 seconds.

In the embodiment, in actual operation, the user is able to adjust a value of the preset time according to needs. For example, during a time period with a large flow of consumers, the preset time is set to a small value to speed up an ice cream making speed. During a time period with a small flow of consumers, the preset time is set to a large value to reduce energy consumption and extend service life of the ice cream maker.

In the embodiment, the preset time is allowed to be adjusted through the control panel of the ice cream maker 100. The user is able to select an appropriate duration according to actual requirements. The preset time is less than 25 minutes, 20 minutes, or 15 minutes. If the preset time is too large, the ice cream may melt excessively, and the ice cream re-overrun mode may require a longer time.

In the embodiment, the ice cream re-overrun mode is triggered when the preset time is exceeded after the completion of the ice cream making mode, the refrigeration device 40 and the stirring device 30 are simultaneously activated for at least 10 seconds. If an operation duration of the refrigeration device 40 and the stirring device 30 is too short, a re-overrun effect of the ice cream is poor. Optionally, the operation duration of the refrigeration device 40 and the stirring device 30 is 20 seconds to 180 seconds. Preferably, the operation duration of the refrigeration device 40 and the stirring device 30 is 30 seconds to 120 seconds.

In the embodiment, the ice cream re-overrun mode is triggered when the preset time is exceeded after the completion of the ice cream making mode; and when the temperature of the refrigeration container 20 reaches the preset temperature, the refrigeration device 40 first stops refrigerating, and then the stirring device 30 stops stirring after a second predetermined time. Due to the existence of thermal inertia in the refrigeration device 40, the temperature of the ice cream does not immediately stabilize at the preset temperature, but undergoes the brief process of continuing to drop, and then gradually tends to stabilize. At this time, during the continuous stirring process of the stirring device 30, the problem of local freezing of the ice cream is avoided. The second predetermined time is greater than 5 seconds. Optionally, the second predetermined time is greater than 10 seconds.

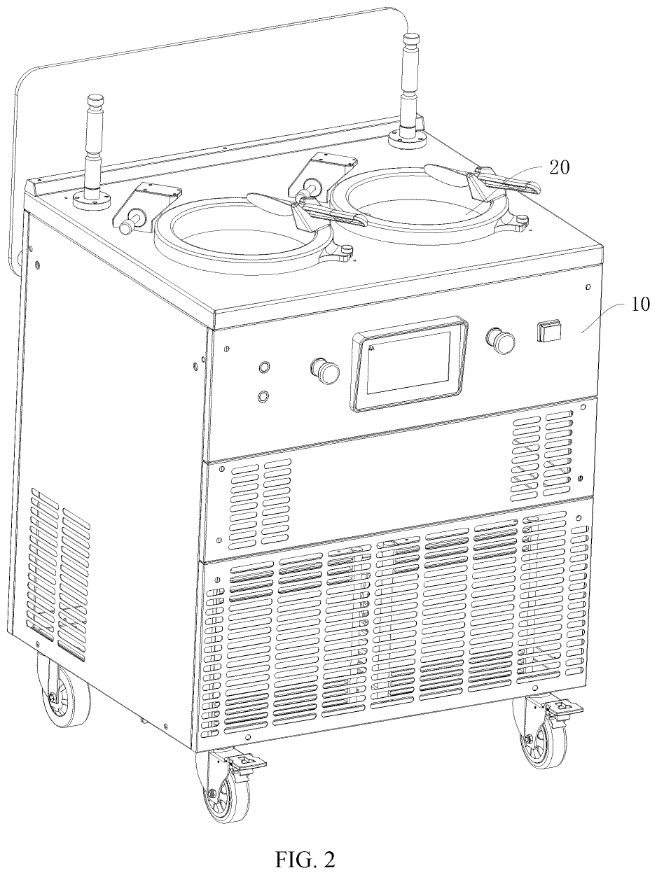

In the embodiment, as shown in FIG. 1 and FIG. 2, a structure of the machine body 10 is not strictly limited, as long as the machine body 10 is able to support structures such as the refrigeration container 20. For example, the structure of the machine body 10 is a frame structure. Four casters are installed on a bottom portion of the machine body 10, which enables the ice cream maker 100 to be moved flexibly.

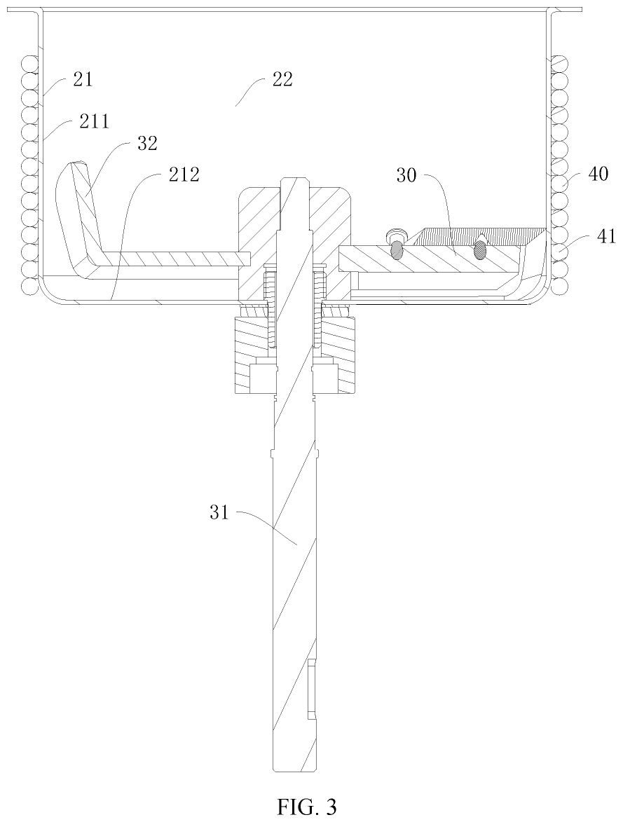

In the embodiment, as shown in FIG. 2 and FIG. 3, the refrigeration container 20 is substantially cylindrical. The refrigeration container 20 comprises an accommodating cavity 22 with an opening. The refrigeration container 20 comprises a bottom wall 212 and a side wall 211. The bottom wall 212 and the side wall 211 are enclosed to define the accommodating cavity 22. The bottom wall 212 is substantially disc-shaped; the side wall 211 has a cylindrical structure. A first end of the side wall 211 along its own axis (i.e., one end away from the bottom wall) is open to form the opening, and a second end of the side wall 211 is connected to the bottom wall 212. A flange is disposed on an edge of the opening of the refrigeration container 20. A through hole corresponding to the refrigeration container 20 is defined on a top portion of the machine body 10. The refrigeration container 20 is embedded in the through hole of the machine body 10, and the flange thereof overlaps on a top surface of the top portion of the machine body 10.

In the embodiment, as shown in FIG. 1 to FIG. 2, the ice cream maker 100 further comprises a transparent lid 23 configured to cover the opening of the refrigeration container 20. The user is able to view the ice cream in the refrigeration container 20 through the transparent lid 23. The transparent lid 23 is made of glass or plastic. The transparent lid 23 is rotatably installed on the machine body 10 via a pivot or other structures.

In the embodiment, as shown in FIG. 3, a structure of the refrigeration device 40 is not strictly limited, as long as the refrigeration device 40 is able to freeze and solidify the ice cream in the refrigeration container 20. The refrigeration device 40 comprises refrigeration pipes 41. The refrigeration pipes 41 are disposed around the refrigeration container 20 to substantially form a cylindrical structure to wrap the refrigeration container 20. The refrigeration pipes 41 are in close contact with or in a clearance fit with the bottom wall 212 of the refrigeration container 20. Along a vertical direction, the refrigeration pipes 41 are higher than, lower than, or flush with a position defining a maximum production capacity of the refrigeration container 20.

In the embodiment, as shown in FIG. 3, the stirring device 30 comprises a rotating shaft 31 configured to output rotational power and a stirring paddle 32 disposed on the rotating shaft 31. A motor rotates the rotating shaft 31 to drive the stirring paddle 32 to stir the ice cream in the refrigeration container 20.

The technical features of the above embodiments are combined in any manner For the sake of concise description, all possible combinations of the technical features in the above embodiments are not described. However, as long as there is no contradiction in the combination of these technical features, the combinations are considered to be within the scope recorded in the specification. When technical features from different embodiments are illustrated in the same drawing, that drawing may be deemed to simultaneously disclose combinations of the respective embodiments involved.

The above-mentioned embodiments only express several embodiments of the present disclosure, and the description thereof is relatively specific and detailed, but should not be construed as a limitation on the scope of the present disclosure. It should be noted that for those of ordinary skill in the art, several modifications and improvements can be made without departing from the concept of the present disclosure, and these modifications and improvements should fall within the protection scope of the present disclosure.

What is claimed is:

1. An ice cream maker, comprising: a machine body, at least one refrigeration container, at least one refrigeration device, and at least one stirring device;
wherein the at least one stirring device is configured to stir ice cream within the at least one refrigeration container;
wherein the ice cream maker has an ice cream making mode and an ice cream re-overrun mode;
wherein after completion of ice cream making in the ice cream making mode, the ice cream re-overrun mode is triggered when at least one of a first condition and a second condition is met; wherein the first condition is that a temperature of the at least one refrigeration container exceeds a preset temperature, and the second condition is that a preset time is exceeded after completion of the ice cream making mode;
wherein in the ice cream re-overrun mode, the at least one refrigeration device is configured to supply cooling energy to the at least one refrigeration container to lower the temperature of the at least one refrigeration container, and the at least one stirring device is configured to incorporate air into the ice cream by stirring the ice cream to achieve a re-overrun of the ice cream.

2. The ice cream maker according to claim 1, wherein the ice cream re-overrun mode is triggered when the temperature of the at least one refrigeration container exceeds the preset temperature, and the at least one stirring device stops stirring when the temperature of the at least one refrigeration container reaches the preset temperature.

3. The ice cream maker according to claim 1, wherein the ice cream re-overrun mode is triggered when the temperature of the at least one refrigeration container exceeds the preset temperature, and the at least one refrigeration device stops refrigerating when the temperature of the at least one refrigeration container reaches the preset temperature.

4. The ice cream maker according to claim 1, wherein the ice cream re-overrun mode is triggered when the temperature of the at least one refrigeration container exceeds the preset temperature, and when the temperature of the at least one refrigeration container reaches the preset temperature, the at least one refrigeration device first stops refrigerating, and then the at least one stirring device stops stirring after a first predetermined time.

5. The ice cream maker according to claim 4, wherein the first predetermined time is greater than 5 seconds.

6. The ice cream maker according to claim 1, wherein the preset temperature is −15° C. to −3° C. .

7. The ice cream maker according to claim 6, wherein the preset temperature is −12° C. to −5° C. .

8. The ice cream maker according to claim 1, wherein the ice cream re-overrun mode is triggered when the preset time is exceeded after the completion of the ice cream making mode, and in the ice cream re-overrun mode, the at least one refrigeration device and the at least one stirring device are simultaneously activated for at least 10 seconds.

9. The ice cream maker according to claim 8, wherein the ice cream re-overrun mode is triggered when the preset time is exceeded after the completion of the ice cream making mode, and when the temperature of the at least one refrigeration container reaches the preset temperature, the at least one refrigeration device first stops refrigerating, and then the at least one stirring device stops stirring after a second predetermined time.

10. The ice cream maker according to claim 1, wherein the preset time is less than 25 minutes.
